(19) United States
(12) Patent Application Publication
(10) Pub. No.: US 2026/0059597 A1
(43) Pub. Date: Feb. 26, 2026

(54) METHOD AND APPARATUS FOR IMPLEMENTING MULTI-ACCESS COMMUNICATION

(71) Applicant: BEIJING XIAOMI MOBILE SOFTWARE CO., LTD., Beijing (CN)

(72) Inventors: Yuxin MAO, Beijing (CN); Jinhua WU, Beijing (CN); Yang SHEN, Beijing (CN)

(21) Appl. No.: 19/104,343

(22) PCT Filed: Aug. 22, 2022
(86) PCT No.: PCT/CN2022/114062

§ 371 Date: Feb. 17, 2025

(51) Int. Cl. H04W 76/16; H04W 60/04; H04W 76/30

(52) U.S. Cl. CPC H04W 76/16; H04W 60/04; H04W 76/30

(57) ABSTRACT

A method for implementing a multi-access communication includes: obtaining an access type and a radio access technology type used by a terminal device for an access, sending the access type and the radio access technology type to a different network element, and performing a user plane operation with the terminal device according to the access type and the radio access technology type.

### CROSS-REFERENCE TO RELATED APPLICATION

This application is a national phase entry under 35 USC § 371 of International Application PCT/CN2022/114062 filed on Aug. 22, 2022, the entire content of which is incorporated herein by reference.

### TECHNICAL FIELD

The present disclosure generally relates to the field of communication technologies, and more particularly relates to a method and an apparatus for implementing a multi-access communication.

### BACKGROUND

A terminal device supporting access traffic steering, switching, splitting (ATSSS) features uses the 3rd generation partnership project (3GPP) access and the non-3GPP access to establish multi-access protocol data unit (MA PDU) session connection services at the same time, so that multiple channels may be used simultaneously for the data stream transmission between the terminal device and a data network. In the process of establishing an MA PDU session, the 3GPP access and the non-3GPP access are mainly distinguished by means of access types in the related art.

With the enrichment of access technologies and the expansion of the application field of ATSSS features, when the terminal device simultaneously uses multiple 3GPP accesses to support ATSSS features, for example, when the terminal device simultaneously uses two types of 3GPP accesses, i.e. a new radio (NR) access and a non-terrestrial network (NTN) access (such as satellite access), since the NR and NTN accesses are both access technologies under the 3GPP access, in the related art, in case that the terminal device uses multiple 3GPP accesses, the core network element cannot further distinguish the access technologies used by the terminal device according to the access types, and thus cannot perform subsequent user plane operations with the terminal device.

### SUMMARY

In a first aspect, embodiments of the present disclosure provide a method for implementing a multi-access communication, including: obtaining an access type and a radio access technology type used by a terminal device for an access, sending the access type and the radio access technology type to a different network element, and performing a user plane operation with the terminal device according to the access type and the radio access technology type.

In a second aspect, embodiments of the present disclosure provide another method for implementing a multi-access communication, including: obtaining from a first network element an access type and a radio access technology type used by a terminal device for an access, and establishing an MA PDU session with the terminal device according to the access type and the radio access technology type.

In a third aspect, embodiments of the present disclosure provide another method for implementing a multi-access communication, including: obtaining an access type and a radio access technology type used by a terminal device for an access; sending the access type and the radio access technology type to a different network element; performing a user plane operation with the terminal device according to the access type and the radio access technology type; obtaining from a first network element the access type and the radio access technology type used by the terminal device for the access; and establishing an MA PDU session with the terminal device via an access network indicated by the access type and the radio access technology type.

In a fourth aspect, embodiments of the present disclosure provide a system for implementing a multi-access communication, including a first network element and a second network element. The first network element is configured to obtain an access type and a radio access technology type used by a terminal device for an access, send the access type and the radio access technology type to a different network element, and perform a user plane operation with the terminal device according to the access type and the radio access technology type. The second network element is configured to obtain from the first network element the access type and the radio access technology type used by the terminal device for the access, and establish an MA PDU session with the terminal device via an access network indicated by the access type and the radio access technology type.

In a fifth aspect, embodiments of the present disclosure provide a communication device, which has some or all of the functions of the terminal device in the method described above in the first aspect. For example, the functions of the communication device may have some or all of the functions in the embodiments of the present disclosure, or may have the functions of implementing any one of the embodiments of the present disclosure alone. The functions may be implemented by hardware, or may be implemented by hardware executing corresponding software. The hardware or software includes one or more units or modules corresponding to the above functions.

In an implementation, the communication device may include a transceiver module and a processing module, and the processing module is configured to support the communication device to perform the corresponding functions in the above method. The transceiver module is used to support the communication between the communication device and other devices. The communication device may further include a storage module, which is used to couple with the transceiver module and the processing module, and store desired computer programs and data for the communication device.

In a sixth aspect, embodiments of the present disclosure provide another communication device, which has some or all of the functions of the network device in the method example described above in the second aspect. For example, the functions of the communication device may have some or all of the functions in the embodiments of the present disclosure, or may have the functions of implementing any one of the embodiments of the present disclosure alone. The functions may be implemented by hardware, or may be implemented by hardware executing corresponding software. The hardware or software includes one or more units or modules corresponding to the above functions.

In an implementation, the communication device may include a transceiver module and a processing module, and the processing module is configured to support the communication device to perform the corresponding functions in the above method. The transceiver module is used to support the communication between the communication device and other devices. The communication device may further include a storage module, which is used to couple with the transceiver module and the processing module, and store desired computer programs and data for the communication device.

In a seventh aspect, embodiments of the present disclosure provide a communication device, which includes a processor. When the processor calls a computer program in a memory, the method described above in the first aspect is performed.

In an eighth aspect, embodiments of the present disclosure provide a communication device, which includes a processor. When the processor calls a computer program in a memory, the method described above in the second aspect is performed.

In a ninth aspect, embodiments of the present disclosure provide a communication device, which includes a processor and a memory having stored therein a computer program. The processor executes the computer program stored in the memory, so that the communication device performs the method described above in the first aspect.

In a tenth aspect, embodiments of the present disclosure provide a communication device, which includes a processor and a memory having stored therein a computer program. The processor executes the computer program stored in the memory, so that the communication device performs the method described above in the second aspect.

In an eleventh aspect, embodiments of the present disclosure provide a communication device, which includes a processor and an interface circuit, in which the interface circuit is configured to receive code instructions and transmit the code instructions to the processor, and the processor is configured to run the code instructions to enable the device to execute the method described above in the first aspect.

In a twelfth aspect, embodiments of the present disclosure provide a communication device, which includes a processor and an interface circuit, in which the interface circuit is configured to receive code instructions and transmit the code instructions to the processor, and the processor is configured to run the code instructions to enable the device to execute the method described above in the second aspect.

In a thirteenth aspect, embodiments of the present disclosure provide a communication system. The system includes the communication device described in the third aspect and the communication device described in the fourth aspect, or the system includes the communication device described in the fifth aspect and the communication device described in the sixth aspect, or the system includes the communication device described in the seventh aspect and the communication device described in the eighth aspect, or the system includes the communication device described in the ninth aspect and the communication device described in the tenth aspect.

In a fourteenth aspect, embodiments of the present disclosure provide a computer-readable storage medium for storing instructions used by the above-mentioned terminal device, and when the instructions are executed, the terminal device performs the method described above in the first aspect.

In a fifteenth aspect, embodiments of the present disclosure provide a readable storage medium for storing instructions used by the above-mentioned network device, and when the instructions are executed, the network device performs the method described above in the second aspect.

In a sixteenth aspect, the present disclosure further provides a computer program product including a computer program, and when the computer program is run on a computer, the computer is enabled to execute the method described above in the first aspect.

In a seventeenth aspect, the present disclosure further provides a computer program product comprising a computer program, and when the computer program is run on a computer, the computer is enabled to execute the method described above in the second aspect.

In an eighteenth aspect, the present disclosure provides a chip system, which includes at least one processor and an interface, used to support a terminal device to implement the functions involved in the first aspect, for example, determining or processing at least one of the data and information involved in the above method. In a possible design, the chip system further includes a memory, which is used to store desired computer programs and data for the terminal device. The chip system may be composed of a chip, or may include a chip and other discrete devices.

In a nineteenth aspect, the present disclosure provides a chip system, which includes at least one processor and an interface, used to support a network device to implement the functions involved in the second aspect, for example, determining or processing at least one of the data and information involved in the above method. In a possible design, the chip system further includes a memory, and the memory is used to store desired computer programs and data for the network device. The chip system may be composed of a chip, or may include a chip and other discrete devices.

In a twentieth aspect, the present disclosure provides a computer program, and when the computer program is run on a computer, the computer is enabled to perform the method described above in the first aspect.

In a twenty-first aspect, the present disclosure provides a computer program, and when the computer program is run on a computer, the computer is enabled to perform the method described above in the second aspect.

### BRIEF DESCRIPTION OF THE DRAWINGS

In order to more clearly illustrate the technical solutions in the embodiments of the present disclosure or the background, the drawings used in the embodiments of the present disclosure or the background will be described below.

FIG. 1 is a schematic diagram of an architecture of a communication system provided in an embodiment of the present disclosure.

FIG. 2 is a schematic flowchart of a method for implementing a multi-access communication provided in an embodiment of the present disclosure.

FIG. 3 is a schematic flowchart of another method for implementing a multi-access communication provided in an embodiment of the present disclosure.

FIG. 4 is a schematic flowchart of another method for implementing a multi-access communication provided in an embodiment of the present disclosure.

FIG. 5 is a schematic flowchart of another method for implementing a multi-access communication provided in an embodiment of the present disclosure.

FIG. 6 is a schematic flowchart of another method for implementing a multi-access communication provided in an embodiment of the present disclosure.

FIG. 7 is a schematic flowchart of another method for implementing a multi-access communication provided in an embodiment of the present disclosure.

FIG. 8 is a schematic flowchart of another method for implementing a multi-access communication provided in an embodiment of the present disclosure.

FIG. 9 is a schematic flowchart of another method for implementing a multi-access communication provided in an embodiment of the present disclosure.

FIG. 10 is a schematic flowchart of another method for implementing a multi-access communication provided in an embodiment of the present disclosure.

FIG. 11 is a schematic flowchart of another method for implementing a multi-access communication provided in an embodiment of the present disclosure.

FIG. 12 is a schematic diagram of a service request procedure provided in an embodiment of the present disclosure.

FIG. 13 is a schematic flowchart of another method for implementing a multi-access communication provided in an embodiment of the present disclosure.

FIG. 14 is a schematic block diagram of a system for implementing a multi-access communication provided in an embodiment of the present disclosure.

FIG. 15 is a schematic block diagram of a communication device provided in an embodiment of the present disclosure.

FIG. 16 is a schematic block diagram of another communication device provided in an embodiment of the present disclosure.

FIG. 17 is a schematic block diagram of a chip provided in an embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the disclosure as recited in the appended claims.

Terms used herein in embodiments of the present disclosure are only for the purpose of describing specific embodiments, but should not be construed to limit embodiments of the present disclosure. As used in the embodiments of the present disclosure and the appended claims, “a/an”, and “the” in singular forms are intended to include plural forms, unless clearly indicated in the context otherwise. It should also be understood that the term “and/or” used herein represents and contains any or all possible combinations of one or more associated listed items.

It should be understood that, although terms such as “first,” “second” and “third” may be used in embodiments of the present disclosure for describing various information, these information should not be limited by these terms. These terms are only used for distinguishing information of the same type from each other. For example, first information may also be referred to as second information, and similarly the second information may also be referred to as the first information, without departing from the scope of embodiments of the present disclosure. As used herein, the term “if” may be construed to mean “when” or “upon” or “in response to determining” depending on the context. For the purpose of brevity and ease of the understanding, the terms used in this document to represent size relationships are “greater than” or “less than”, “higher than” or “lower than”. However, it may be understood by those skilled in the art that the term “greater than” also covers the meaning of “greater than or equal to”, and the term “less than” also covers the meaning of “less than or equal to”; the term “higher than” covers the meaning of “higher than or equal to”, and the term “lower than”also covers the meaning of “lower than or equal to”.

User plane: a protocol responsible for transmitting and processing user data flows in a wireless communication system.

In order to better understand a method for implementing a multi-access communication in an embodiment of the present disclosure, a communication system to which the embodiment of the present disclosure is applicable is first described below.

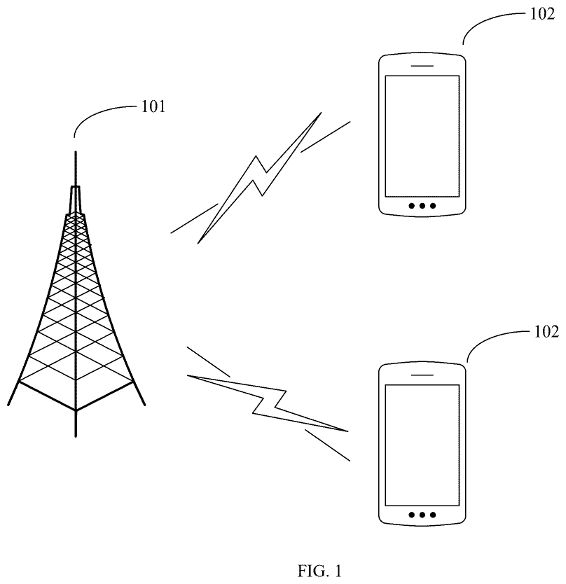

FIG. 1 is a schematic diagram of the architecture of a communication system provided in an embodiment of the present disclosure. The communication system may include, but is not limited to, one network device and one terminal device. The number and form of devices shown in FIG. 1 are only used as examples and do not constitute a limitation on the embodiments of the present disclosure. In actual applications, two or more network devices and two or more terminals may be included. The communication system shown in FIG. 1 includes, for example, a network device 101 and a terminal device 102.

It should be noted that the technical solution in the embodiment of the present disclosure may be applied to various communication systems, such as a long term evolution (LTE) system, a fifth generation (5G) mobile communication system, a 5G new radio (NR) system, or other future new mobile communication systems. It should also be noted that the sidelink in an embodiment of the present disclosure may also be called a side link or a direct link.

The network device 101 in an embodiment of the present disclosure is an entity on the network side for transmitting or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (Wi-Fi) system. The specific technology and specific device form adopted by the network device are not limited in the embodiment of the present disclosure. The network device provided in an embodiment of the present disclosure may include a central unit (CU) and a distributed unit (DU), in which the CU may also be referred to as a control unit. The CU-DU structure may be used to split the protocol layer of the network device, such as the base station, and the functions of some protocol layers are placed in the CU for centralized control, and the functions of the remaining part or all of the protocol layers are distributed in the DU, and the DU is centrally controlled by the CU.

The terminal device 102 in an embodiment of the present disclosure is an entity on the user side for receiving or transmitting signals, such as a mobile phone. The terminal device may also be referred to as a terminal, a user equipment (UE), a mobile station (MS), a mobile terminal (MT), etc. The terminal device may be a car with a communication function, a smart car, a mobile phone, a wearable device, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in the embodiment of the present disclosure.

In sidelink communication, there are 4 sidelink transmission modes. Side link transmission mode 1 and side link transmission mode 2 are used for a device-to-device (D2D) communication of the terminal device. Sidelink transmission mode 3 and sidelink transmission mode 4 are used for a V2X communication. When sidelink transmission mode 3 is adopted, resource allocation is scheduled by the network device 101. Specifically, the network device 101 may send resource allocation information to the terminal device 102, and then the terminal device 102 allocates resources to a different terminal device, so that the different terminal device can send information to the network device 101 through the allocated resources. In the V2X communication, a terminal device with a better signal or higher reliability may be used as the terminal device 102. The first terminal device mentioned in the embodiment of the present disclosure may refer to the terminal device 102, and the second terminal device may refer to the different terminal device.

It may be understood that the communication system described in an embodiment of the present disclosure is for the purpose of more clearly illustrating the technical solution of the embodiment of the present disclosure, and does not constitute a limitation on the technical solution provided in the embodiment of the present disclosure. Those of ordinary skill in the art may know that with the evolution of the system architecture and the emergence of new business scenarios, the technical solution provided in the embodiment of the present disclosure is also applicable to similar technical problems.

It should be noted that the method for indicating the coefficient provided in any embodiment of the present disclosure may be executed alone, or may be executed in combination with possible implementation methods in other embodiments, or may be executed in combination with any technical solution in the related technology.

Embodiments of the present disclosure provide a method and an apparatus for implementing a multi-access communication, which can solve the problem that when a terminal device uses multiple 3GPP accesses to support ATSSS features, the access technologies used by the terminal device cannot be further distinguished in case of 3GPP accesses in the related art, and thus subsequent user plane operations with the terminal device cannot be performed.

The method and the apparatus for implementing the multi-access communication provided in the present disclosure are described in detail below in conjunction with the accompanying drawings.

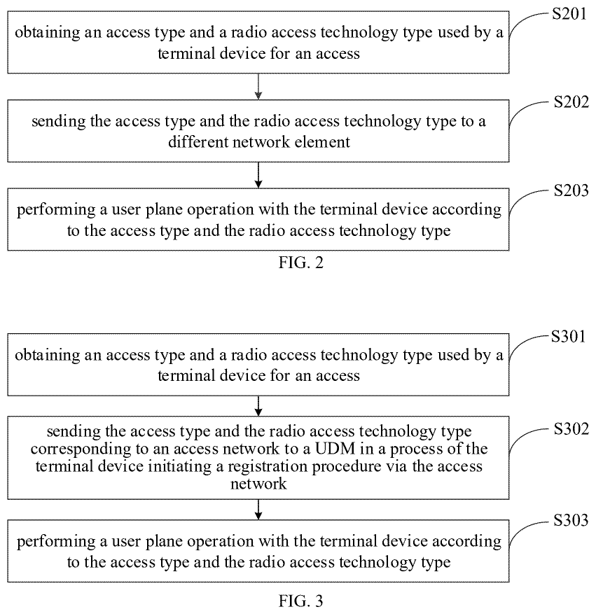

FIG. 2 is a schematic flowchart of a method for implementing a multi-access communication provided in an embodiment of the present disclosure. It should be noted that the method for implementing the multi-access communication is performed by a first network element. Optionally, the first network element includes an access and mobility management function (AMF). The method for implementing the multi-access communication provided in the embodiment of the present disclosure is explained below using the AMF as the first network element as an example.

As shown in FIG. 2, the method includes, but is not limited to, the following steps.

At step S201, an access type and a radio access technology type used by a terminal device for an access are obtained.

The access type includes a 3GPP access and a non-3GPP access. The 3GPP access includes, but is not limited to, an NR access, a LTE access, a new radio low Earth orbit satellite (NR-LEO) access, a new radio medium Earth orbit satellite (NR-MEO) access, a new radio geosynchronous Earth orbit satellite (NR-GEO) access, and the like. The non-3GPP access includes, but is not limited to, a wireless local area network (WLAN), and the like.

In order to distinguish the 3GPP accesses, the 3GPP accesses are further refined, and different access network types such as NR, LTE, NR-LEO, NR-MEO, NR-GEO accesses, and the like are referred to as radio access technology types in the embodiment of the present disclosure.

When the terminal device performs an access registration via an access network, the AMF obtains the access type and the radio access technology type corresponding to the access network. When the terminal device performs an access registration via two access networks, for example, NR and NR-LEO networks, each of the two access networks corresponds to one access type and one radio access technology type.

At step S202, the access type and the radio access technology type are sent to a different network element.

Optionally, the different network element includes, but is not limited to, a session management function (SMF), a policy control function (PCF), a unified data management (UDM), and other network elements.

When the terminal device initiates a registration procedure, as part of the registration procedure, the AMF needs to send the access type and the radio access technology type used by the terminal device for the access to other network elements such as an SMF, a PCF, a UDM, or the like to be saved as part of the context of the terminal device.

At step S203, a user plane operation with the terminal device is performed according to the access type and the radio access technology type.

The user plane operation with the terminal device is performed via an access network indicated by the access type and the radio access technology type.

When the access type used by the terminal device for the access is a 3GPP access, the access network used by the terminal device may be further determined based on the radio access technology type used by the terminal device for the access, and user-plane operations such as the establishment, modification and releasing of an MAPDU session, as well as service requests and ATSSS rule formulation may be performed with the terminal device via the access network.

For example, in case that the access network indicated by the access type and the radio access technology type used by the terminal device for the access is an NR network, then user-plane operations such as the establishment, modification and releasing of an MA PDU session, as well as service requests and ATSSS rule formulation may be performed with the terminal device via the NR network.

In the embodiment of the present disclosure, the access type and the radio access technology type used by the terminal device for the access are obtained, the access type and the radio access technology type are sent to the different network element, and the user plane operation with the terminal device is performed according to the access type and the radio access technology type. In the embodiment of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access, and thus an access network used by the terminal device may be determined and the user plane operation with the terminal device may be performed.

FIG. 3 is a schematic flowchart of a method for implementing a multi-access communication provided in an embodiment of the present disclosure. The method for implementing the multi-access communication is performed by a first network element. The method for implementing the multi-access communication provided in the embodiment of the present disclosure is explained below using an AMF as the first network element as an example. As shown in FIG. 3, the method includes, but is not limited to, the following steps.

At step S301, an access type and a radio access technology type used by a terminal device for an access are obtained.

Regarding the detailed description of step S301, reference is made to the relevant contents in the above embodiment, which will not be repeated here.

At step S302, the access type and the radio access technology type corresponding to an access network are sent to a UDM in a process of the terminal device initiating a registration procedure via the access network, in which the registration procedure includes at least one of an initial registration, a periodic registration, or a registration update.

In some embodiments, during the process of the terminal device initiating the registration procedure via the access network, the AMF may send a Nudm_UECM_Registration message to the UDM, in which the Nudm_UECM_Registration message includes the access type and the radio access technology type corresponding to the access network, so as to send the access type and the radio access technology type corresponding to the access network to the UDM to be saved as the context of the terminal device.

At step S303, a user plane operation with the terminal device is performed according to the access type and the radio access technology type.

Regarding the detailed description of step S303, reference is made to the relevant contents in the above embodiment, which will not be repeated here.

In the embodiment of the present disclosure, the access type and the radio access technology type used by the terminal device for the access are obtained, the access type and the radio access technology type corresponding to the access network are sent to the UDM in the process of the terminal device initiating the registration procedure via the access network, and the user plane operation with the terminal device is performed according to the access type and the radio access technology type. In the embodiment of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access, and thus an access network used by the terminal device may be determined and the user plane operation with the terminal device may be performed.

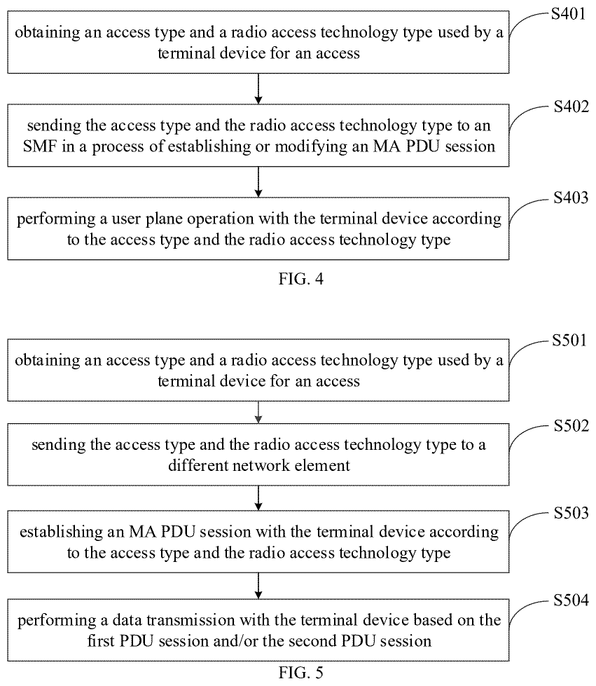

FIG. 4 is a schematic flowchart of a method for implementing a multi-access communication provided in an embodiment of the present disclosure. The method for implementing the multi-access communication is performed by a first network element. The method for implementing the multi-access communication provided in the embodiment of the present disclosure is explained below using an AMF as the first network element as an example. As shown in FIG. 4, the method includes, but is not limited to, the following steps.

At step S401, an access type and a radio access technology type used by a terminal device for an access are obtained.

Regarding the detailed description of step S401, reference is made to the relevant contents in the above embodiments, which will not be repeated here.

At step S402, the access type and the radio access technology type are sent to an SMF in a process of establishing or modifying an MA PDU session.

After the AMF obtains the access type and the radio access technology type used by the terminal device for the access, the AMF may establish or modify the MA PDU session via the access network indicated by the access type and the radio access technology type, and send the access type and the radio access technology type to the SMF during the establishment or modification of the MA PDU session.

At step S403, a user plane operation with the terminal device is performed according to the access type and the radio access technology type.

Regarding the detailed description of step S403, reference is made to the relevant contents in the above embodiments, which will not be repeated here.

In the embodiment of the present disclosure, the access type and the radio access technology type used by the terminal device for the access are obtained, the access type and the radio access technology type are sent to the SMF in the process of establishing or modifying the MA PDU session, and the user plane operation with the terminal device is performed according to the access type and the radio access technology type. In the embodiment of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access, and thus an access network used by the terminal device may be determined and the user plane operation with the terminal device may be performed.

FIG. 5 is a schematic flowchart of a method for implementing a multi-access communication provided in an embodiment of the present disclosure. The method for implementing the multi-access communication is performed by a first network element. The method for implementing the multi-access communication provided in the embodiment of the present disclosure is explained below using an AMF as the first network element as an example. As shown in FIG. 5, the method includes, but is not limited to, the following steps.

At step S501, an access type and a radio access technology type used by a terminal device for an access are obtained.

At step S502, the access type and the radio access technology type are sent to a different network element.

Regarding the detailed description of steps S501 and S502, reference is made to the relevant contents in the above embodiments, which will not be repeated here.

At step S503, an MA PDU session with the terminal device is established according to the access type and the radio access technology type.

The MA PDU session with the terminal device is performed via an access network indicated by the access type and the radio access technology type used by the terminal device for the access.

Optionally, the MA PDU session includes a first PDU session and a second PDU session.

The first PDU session is a PDU session established via a first access network indicated by a first access type and a first radio access technology type, and the second PDU session is a PDU session established via a second access network indicated by a second access type and a second radio access technology type.

For example, assuming that the first access network indicated by the first access type and the first radio access technology type is an NR network and the second access network indicated by the second access type and the second radio access type is an NR-LEO network, a first PDU session is established between a core network and the terminal device via the NR network, and a second PDU session is established between the core network and the terminal device via the NR-LEO network.

At step S504, a data transmission with the terminal device is performed based on the first PDU session and/or the second PDU session.

After the first PDU session and the second PDU session with the terminal device are established, the downlink data transmission may be performed with the terminal device through the first PDU session and/or the second PDU session.

In the embodiment of the present disclosure, the access type and the radio access technology type used by the terminal device for the access are obtained, the access type and the radio access technology type are sent to the different network element, the MA PDU session with the terminal device is established according to the access type and the radio access technology type, and the data transmission with the terminal device is performed based on the first PDU session and/or the second PDU session. In the embodiment of the present disclosure, when the terminal device simultaneously uses different access networks, the different access networks may be distinguished according to the access types and the radio access technology types used by the terminal device for the access, and MA PDU sessions may be established between the different access networks and the terminal device to achieve the multi-channel data transmission, thereby increasing the data transmission bandwidth and thus improving the data transmission efficiency and avoiding the network congestion.

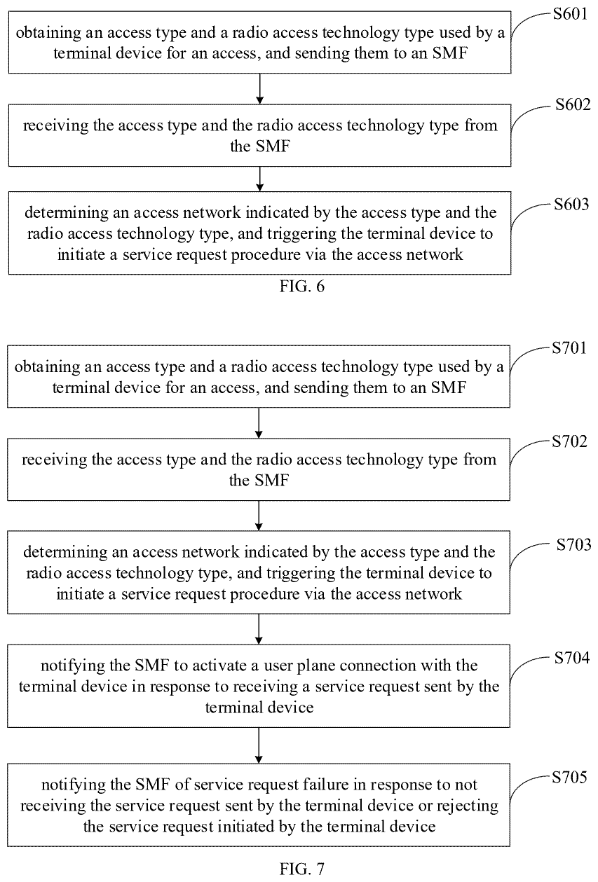

FIG. 6 is a schematic flowchart of a method for implementing a multi-access communication provided in an embodiment of the present disclosure. The method for implementing the multi-access communication is performed by a first network element. The method for implementing the multi-access communication provided in the embodiment of the present disclosure is explained below using an AMF as the first network element as an example. As shown in FIG. 6, the method includes, but is not limited to, the following steps.

At step S601, an access type and a radio access technology type used by a terminal device for an access are obtained and sent to an SMF.

When the terminal device initiates a registration, the AMF obtains the access type and the radio access technology type used by the terminal device for the access, and sends the obtained access type and radio access technology type to the SMF.

At step S602, the access type and the radio access technology type are received from the SMF.

After caching the downlink data or receiving a caching notification for caching the downlink data, the SMF determines an access network used for the downlink data. After determining the access network used for the downlink data, the SMF sends a request message to the AMF, in which the request message includes the access type and the radio access technology type corresponding to the access network.

At step S603, an access network indicated by the access type and the radio access technology type is determined, and the terminal device is triggered to initiate a service request procedure via the access network.

After receiving the access type and the radio access technology type sent by the SMF, the AMF triggers the terminal device to initiate a service request procedure via the access network indicated by the access type and the radio access technology type.

For example, in case that the access network indicated by the access type and the radio access technology type is an NR network, the terminal device may be triggered to initiate a service request procedure via the NR network; in case that the access network indicated by the access type and the radio access technology type is an NR-LEO network, the terminal device may be triggered to initiate a service request procedure via the NR-LEO network.

In the embodiment of the present disclosure, the access type and the radio access technology type used by the terminal device for the access are obtained and sent to the SMF, the access type and the radio access technology type are received from the SMF, the access network indicated by the access type and the radio access technology type is determined, and the terminal device is triggered to initiate the service request procedure via the access network. In the embodiment of the present disclosure, the access network used by the terminal device is determined by the access type and the radio access technology type, and the terminal device is triggered to initiate a service request procedure, thereby realizing the data transmission service after the accessing of the terminal device.

FIG. 7 is a schematic flowchart of a method for implementing a multi-access communication provided in an embodiment of the present disclosure. The method for implementing the multi-access communication is performed by a first network element. The method for implementing the multi-access communication provided in the embodiment of the present disclosure is explained below using an AMF as the first network element as an example. As shown in FIG. 7, the method includes, but is not limited to, the following steps.

At step S701, an access type and a radio access technology type used by a terminal device for an access are obtained and sent to an SMF.

At step S702, the access type and the radio access technology type are received from the SMF.

At step S703, an access network indicated by the access type and the radio access technology type is determined, and the terminal device is triggered to initiate a service request procedure via the access network.

Regarding the detailed description of steps S701 to S703, reference is made to the relevant contents in the above embodiment, which will not be repeated here.

When the terminal device is triggered to initiate the service request procedure via the access network, the terminal device generates a service request and sends the service request to the AMF.

At step S704, the SMF is notified to activate a user plane connection with the terminal device in response to receiving the service request sent by the terminal device.

At step S705, the SMF is notified of a service request failure in response to not receiving the service request sent by the terminal device or rejecting the service request initiated by the terminal device.

When the AMF receives the service request sent by the terminal device, the AMF notifies the SMF to activate the user plane connection with the terminal device. When the AMF does not receive the service request sent by the terminal device, or rejects the service request initiated by the terminal device, the AMF sends request failure information for the service request to the SMF to notify the SMF of the service request failure, in which the AMF not receiving the service request sent by the terminal device indicates that the terminal device refuses to initiate the service request procedure.

In the embodiment of the present disclosure, the access type and the radio access technology type are received from the SMF, the access network indicated by the access type and the radio access technology type is determined, the terminal device is triggered to initiate the service request procedure via the access network, the SMF is notified to activate the user plane connection with the terminal device in response to receiving the service request sent by the terminal device, and the SMF is notified of the service request failure in response to not receiving the service request sent by the terminal device or rejecting the service request initiated by the terminal device. In the embodiment of the present disclosure, the SMF is notified to activate the user plane connection with the terminal device to achieve the data transmission with the terminal device.

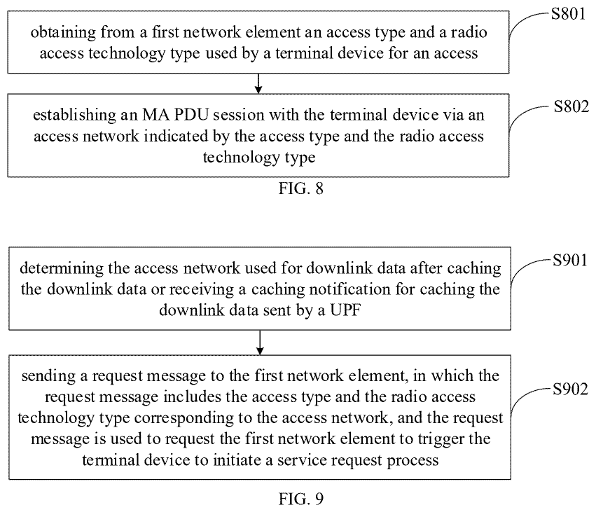

FIG. 8 is a schematic flowchart of a method for implementing a multi-access communication provided in an embodiment of the present disclosure. The method for implementing the multi-access communication is performed by a second network element. Optionally, the second network element includes an SMF. The method for implementing the multi-access communication provided in the embodiment of the present disclosure is explained below using the SMF as the second network element as an example. As shown in FIG. 8, the method includes, but is not limited to, the following steps.

At step S801, an access type and a radio access technology type used by a terminal device for an access are obtained from a first network element.

Optionally, the first network element includes an AMF. The method for implementing the multi-access communication provided in the embodiment of the present disclosure is explained below using the AMF as the first network element as an example.

When the terminal device performs an access registration via an access network, the AMF obtains the access type and the radio access technology type corresponding to the access network, and sends the access type and the radio access technology type to the SMF during the establishment or modification of an MA PDU session.

At step S802, an MA PDU session with the terminal device is established via an access network indicated by the access type and the radio access technology type.

After obtaining the access type and the radio access technology type sent by the AMF, the SMF can establish the MA PDU session with the terminal device via the access network indicated by the access type and the radio access technology type.

In the embodiment of the present disclosure, the access type and the radio access technology type used by the terminal device for the access are obtained from the first network element, and the MA PDU session with the terminal device is established via the access network indicated by the access type and the radio access technology type. In the embodiment of the present disclosure, when the terminal device uses multiple types of 3GPP accesses to support ATSSS features, the 3GPP accesses may be distinguished according to the access type and the radio access technology type used by the terminal device for the access, and thus an access network used by the terminal device may be determined and the MA PDU session with the terminal device may be established.

In one embodiment of the present disclosure, the method for implementing the multi-access communication further includes sending the access type and the radio access technology type to a PCF in a process of establishing or modifying an MA PDU session.

When the terminal device performs an access registration via an access network, the AMF obtains the access type and the radio access technology type corresponding to the access network, and sends the access type and the radio access technology type to the SMF during the establishment or modification of the MA PDU session. After receiving the access type and the radio access technology type sent by the AMF, the SMF sends the access type and the radio access technology type to the PCF through session management policy association establishment or session management policy association modification. The PCF provides MA PDU session-related policies based on the access network indicated by the access type and the radio access technology type.

FIG. 9 is a schematic flowchart of a method for implementing a multi-access communication provided in an embodiment of the present disclosure. The method for implementing the multi-access communication is performed by a second network element. The method for implementing the multi-access communication provided in the embodiment of the present disclosure is explained below using an SMF as the second network element as an example. As shown in FIG. 9, the method includes, but is not limited to, the following steps.

At step S901, the access network used for downlink data is determined after the downlink data is cached or a caching notification for caching the downlink data sent by a user plane function (UPF) is received.

After establishing an MA PDU session with the terminal device, the downlink data may be cached by the SMF or by the UPF. In case that the downlink data is cached by the SMF, then after caching the downlink data, the SMF determines the access network used for the downlink data. In case that the downlink data is cached by the UPF, then after caching the downlink data, the UPF sends a caching notification for caching the downlink data to the SMF, and after receiving the caching notification for caching the downlink data, the SMF determines the access network used for the downlink data.

At step S902, a request message is sent to the first network element, in which the request message includes the access type and the radio access technology type corresponding to the access network, and the request message is used to request the first network element to trigger the terminal device to initiate a service request procedure.

After the access network used for the downlink data is determined, a request message is generated according to the access type and the radio access technology type corresponding to the access network, and sent to the AMF. After receiving the request message, the AMF triggers the terminal device to initiate a service request procedure via the access network indicated by the access type and the radio access technology type in the request message.

In the embodiment of the present disclosure, the access network used for downlink data is determined after the downlink data is cached or the caching notification for caching the downlink data sent by the UPF is received, and the request message is sent to the first network element, in which the request message includes the access type and the radio access technology type corresponding to the access network, and the request message is used to request the AMF to trigger the terminal device to generate the service request. In the embodiment of the present disclosure, the terminal device may be triggered to initiate a service request procedure, thereby realizing the data transmission service after the accessing of the terminal device.

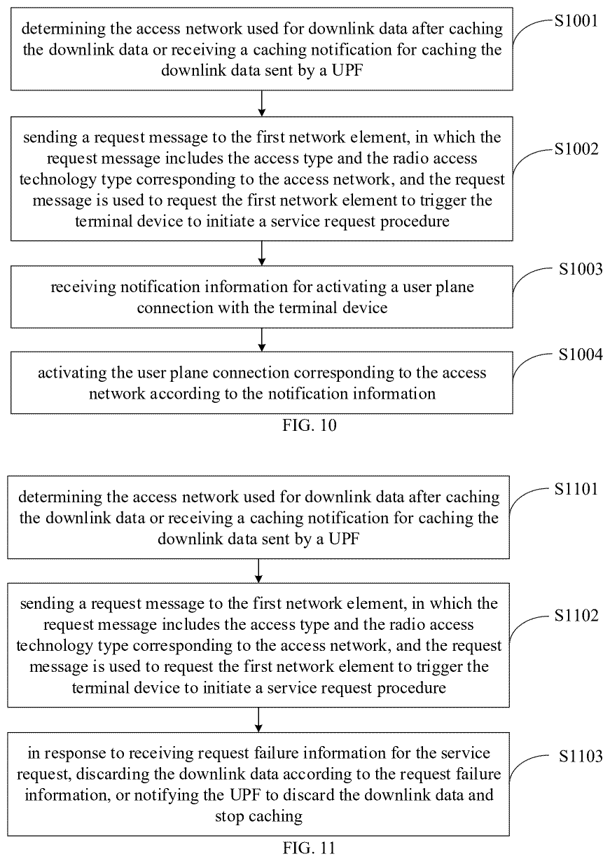

FIG. 10 is a schematic flowchart of a method for implementing a multi-access communication provided in an embodiment of the present disclosure. The method for implementing the multi-access communication is performed by a second network element. The method for implementing the multi-access communication provided in the embodiment of the present disclosure is explained below using an SMF as the second network element as an example. As shown in FIG. 10, the method includes, but is not limited to, the following steps.

At step S1001, the access network used for downlink data is determined after the downlink data is cached or a caching notification for caching the downlink data sent by a UPF is received.

At step S1002, a request message is sent to the first network element, in which the request message includes the access type and the radio access technology type corresponding to the access network, and the request message is used to request the first network element to trigger the terminal device to initiate a service request procedure.

Regarding the detailed description of steps S1001 and S1002, reference is made to the relevant contents in the above embodiment, which will not be repeated here.

At step S1003, notification information for activating a user plane connection with the terminal device is received.

At step S1004, the user plane connection corresponding to the access network is activated according to the notification information.

When the AMF triggers the terminal device to initiate the service request procedure, the terminal device generates a service request and sends the service request to the AMF. After receiving the service request, the AMF sends notification information to the SMF to activate the user plane connection with the terminal device. After receiving the notification information sent by the AMF, the SMF activates the user plane connection corresponding to the access network according to the notification information.

After the user plane connection corresponding to the access network is activated, the SMF can send the cached downlink data through the user plane connection.

In the embodiment of the present disclosure, the access network used for downlink data is determined after the downlink data is cached or the caching notification for caching the downlink data sent by the UPF is received, the request message is sent to the first network element, the request message includes the access type and the radio access technology type corresponding to the access network, the request message is used to request the first network element to trigger the terminal device to initiate the service request procedure, notification information for activating the user plane connection with the terminal device is received, and the user plane connection corresponding to the access network is activated according to the notification information. In the embodiment of the present disclosure, the user plane connection corresponding to the access network may be activated to ensure the normal transmission of the downlink data.

FIG. 11 is a schematic flowchart of a method for implementing a multi-access communication provided in an embodiment of the present disclosure. The method for implementing the multi-access communication is performed by a second network element. The method for implementing the multi-access communication provided in the embodiment of the present disclosure is explained below using an SMF as the second network element as an example. As shown in FIG. 11, the method includes, but is not limited to, the following steps.

At step S1101, the access network used for downlink data is determined after the downlink data is cached or a caching notification for caching the downlink data sent by a UPF is received.

At step S1102, a request message is sent to the first network element, in which the request message includes the access type and the radio access technology type corresponding to the access network, and the request message is used to request the first network element to trigger the terminal device to initiate a service request procedure.

Regarding the detailed description of steps S1101 and S1102, reference is made to the relevant contents in the above embodiments, which will not be repeated here.

At step S1103, in response to receiving request failure information for the service request, the downlink data is discarded according to the request failure information, or the UPF is notified to discard the downlink data and stop caching.

When the terminal device refuses to initiate the service request procedure and does not generate a service request to be sent to the AMF, or when the AMF rejects the service request after receiving the service request sent by the terminal device, the AMF sends request failure information for the service request to the SMF. After receiving the request failure information, the SMF discards the cached downlink data according to the request failure information, or notifies the UPF to discard the cached downlink data and stop caching.

Furthermore, when the SMF discards the downlink data, it releases the user plane access connection or PDU session corresponding to the access network.

In the embodiment of the present disclosure, the access network used for downlink data is determined after the downlink data is cached or the caching notification for caching the downlink data sent by the UPF is received, the request message is sent to the first network element, the request message includes the access type and the radio access technology type corresponding to the access network, the request message is used to request the first network element to trigger the terminal device to initiate the service request procedure, and the downlink data is discarded according to the request failure information for the service request or the UPF is notified to discard the downlink data and stop caching in response to receiving the request failure information. In the embodiment of the present disclosure, when the service request fails, the cached downlink data is discarded, or the UPF is notified to discard the cached downlink data and stop caching, thereby avoiding the waste of resources.

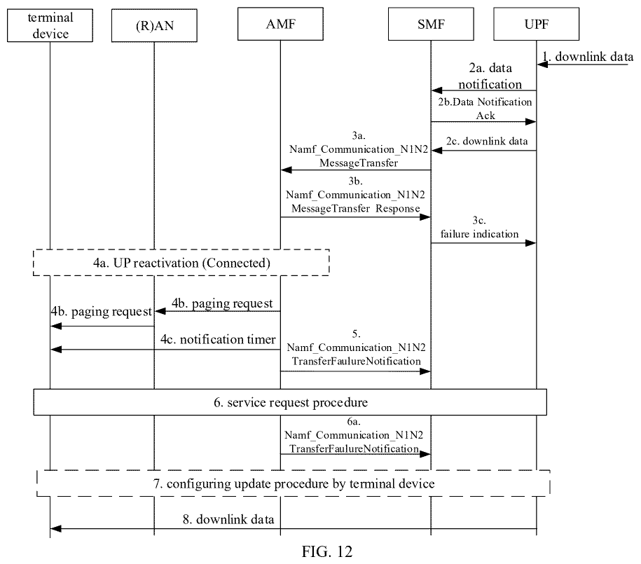

FIG. 12 is a schematic diagram of a network triggered service request procedure. The application of the method for implementing the multi-access communication provided in an embodiment of the present disclosure is explained below in conjunction with FIG. 12.
(1) When a UPF receives downlink data and the UPF has stored therein no access network (AN) tunnel information related to an MA PDU session, according to the instruction from the SMF, the UPF caches the downlink data (steps 2a and 2b) and sends the cached downlink data to the SMF for caching (step 2c).
(2) Step 2a to step 2b: When a first downlink data packet arrives at the UPF, the UPF sends a data notification message to the SMF. In case that a paging differentiation strategy needs to be supported, the UPF needs to include differentiated services code point (DSCP) information contained in the Internet protocol (IP) header of the data packet in the notification message and send it to the SMF. The SMF returns an acknowledge (Ack) message.
Step 2c: In case that the SMF indicates that the data is cached by itself, the UPF sends the downlink data to the SMF for caching.
(3) Step 3a: The SMF sends a Namf_Communication_NIN2MessageTransfer message to the AMF. The Namf_Communication_NIN2MessageTransfer message includes the access type used by the user plane resources to be activated corresponding to the MA PDU session. In case that the access type is a 3GPP access, the radio access technology type used by the user plane resources to be activated also needs to be determined, such as an NR or NR-LEO type.

In addition, when the triple-A authentication server DN-AAA and/or SMF initiate(s) a re-authentication procedure and the SMF calls the Namf_Communication_NIN2MessageTransfer service operation, the SMF needs to indicate to the AMF the access type and the radio access technology type used for the NI non-access stratum (NAS) message sent to the terminal device.
Step 3b: The AMF returns an acknowledge message to the SMF.
Step 3c: In case that the SMF sends a Namf_Communications_NIN2MessageTransfer Failure Notification message from the AMF to notify that the terminal device is inaccessible under the access network indicated by the access type and the radio access technology type, the SMF returns user plane establishment failure information to the UPF. The SMF notifies the UPF to stop data notification, stop caching downlink data, and discard the downlink data.
(4) In case that the terminal device is in a connection management (CM)-IDLE state in the access network indicated by the access type and the radio access technology type, the AMF receives the association relationship between a PDU session identifier and the access type and radio access technology type from the SMF. Based on the access type and the radio access technology type, the AMF decides to use the corresponding access network to send the NI NAS message to the terminal device.

In case that the AMF does not receive the access type and the radio access technology type from the SMF, the terminal device is in a CM-CONNECTED state in two access networks indicated by the access types and the radio access technology types, and the access types and the radio access technology types corresponding to the two access networks are the same, then the AMF can select one access network from the two access networks to send the NI NAS message to the terminal device.
(5) In case that the AMF does not receive the service request sent by the terminal device, or rejects the service request after receiving the service request sent by the terminal device, the AMF notifies the SMF that the corresponding terminal device is inaccessible under the access network indicated by the access type and the radio access technology type. Furthermore, the SMF sends a notification message to a UPF PDU session anchor (UPF-PSA) through a N4 session modification procedure, in which the notification message is used to indicate that the user plane resources established via the access network indicated by the access type and the radio access technology type are unavailable.
(6) When the terminal device is in the CM-IDLE state in the access network indicated by the access type and the radio access technology type, the terminal device is triggered to initiate a service request procedure through a paging request. After the terminal device initiates the service request procedure, a user configuration update procedure is sent to the terminal device, and a new fifth generation globally unique temporary UE identity (5G-GUTI) identifier is allocated to the terminal device. The service request procedure is used to activate the user plane resources corresponding to the access network indicated by the access type and the radio access technology type.
(7) When the SMF discards the downlink data, the user plane connection or PDU session corresponding to the access network is released.
(8) After the user plane resources are activated, the UPF sends the cached downlink data to the terminal device via the access network indicated by the access type and the radio access technology type. In case that the cached downlink data is downlink data cached by the SMF, the SMF sends the cached downlink data to the UPF, and the UPF sends the cached downlink data to the terminal device.

In the above-mentioned embodiments provided in the present disclosure, the methods provided in the embodiments of the present disclosure are introduced from the perspectives of the network device and the terminal device, respectively. In order to implement various functions in the methods provided in the above-mentioned embodiments of the present disclosure, the network device and the first terminal device may include a hardware structure and a software module to implement the above-mentioned functions in the form of a hardware structure, a software module, or a hardware structure plus a software module. Any one of the above functions may be implemented in the form of a hardware structure, a software module, or a hardware structure plus a software module.

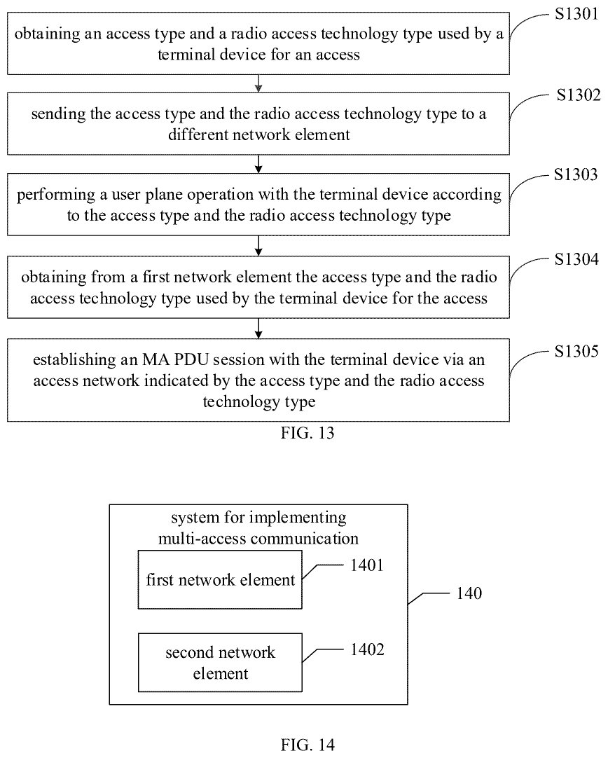

FIG. 13 is a schematic flowchart of a method for implementing a multi-access communication provided in an embodiment of the present disclosure. As shown in FIG. 13, the method includes, but is not limited to, the following steps.

At step S1301, an access type and a radio access technology type used by a terminal device for an access are obtained.

The access type includes a 3GPP access and a non-3GPP access. The 3GPP access includes, but is not limited to, an NR access, a LTE access, an NR-LEO access, an NR-MEO access, an NR-GEO access, and the like. The non-3GPP access includes, but is not limited to, a WLAN, and the like.

In order to distinguish the 3GPP accesses, the 3GPP accesses are further refined, and different access network types such as NR, LTE, NR-LEO, NR-MEO, NR-GEO accesses, and the like are referred to as radio access technology types in the embodiment of the present disclosure.

When the terminal device performs an access registration via an access network, a first network element obtains the access type and the radio access technology type corresponding to the access network.

Optionally, the first network element includes an AMF.

When the terminal device performs an access registration via two access networks, for example, NR and NR-LEO networks, each of the two access networks corresponds to one access type and one radio access technology type.

At step S1302, the access type and the radio access technology type are sent to a different network element.

Optionally, the different network element includes, but is not limited to, an SMF, a PCF, a UDM, and other network elements.

When the terminal device initiates a registration procedure, as part of the registration procedure, the first network element needs to send the access type and the radio access technology type used by the terminal device for the access to other network elements such as an SMF, a PCF, a UDM, or the like to be saved as part of the context of the terminal device.

At step S1303, a user plane operation with the terminal device is performed according to the access type and the radio access technology type.

The first network element performs the user plane operation with the terminal device via an access network indicated by the access type and the radio access technology type.

When the access type used by the terminal device for the access is a 3GPP access, the first network element may further determine the access network used by the terminal device based on the radio access technology type used by the terminal device for the access, and may perform user-plane operations such as the establishment, modification and releasing of an MA PDU session, as well as service requests and ATSSS rule formulation with the terminal device via the access network.

For example, in case that the access network indicated by the access type and the radio access technology type used by the terminal device for the access is an NR network, then the first network element may perform user-plane operations such as the establishment, modification and releasing of an MA PDU session, as well as service requests and ATSSS rule formulation with the terminal device via the NR network.

At step S1304, the access type and the radio access technology type used by the terminal device for the access are obtained from a first network element.

During the process of establishing or modifying the MA PDU session, the second network element obtains the access type and the radio access technology type used by the terminal device for the access from the first network element.

At step S1305, an MA PDU session with the terminal device is established via an access network indicated by the access type and the radio access technology type.

The second network element establishes an MA PDU session with the terminal device via the access network indicated by the access type and the radio access technology type.

In the embodiment of the present disclosure, the access type and the radio access technology type used by the terminal device for the access are obtained, the access type and the radio access technology type are sent to the different network element, the user plane operation with the terminal device is performed according to the access type and the radio access technology type, the access type and the radio access technology type used by the terminal device for the access are obtained from the first network element, and the MA PDU session with the terminal device is established via the access network indicated by the access type and the radio access technology type. In the embodiment of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access. Thus, an access network used by the terminal device may be determined, the user plane operation with the terminal device may be performed, and the MA PDU session with the terminal device may be established.

FIG. 14 is a schematic block diagram of a system for implementing a multi-access communication provided in an embodiment of the present disclosure. As shown in FIG. 14, the system 140 includes a first network element 1401 and a second network element 1402.

The first network element 1401 is configured to obtain an access type and a radio access technology type used by a terminal device for an access, send the access type and the radio access technology type to a different network element, and perform a user plane operation with the terminal device according to the access type and the radio access technology type.

The access type includes a 3GPP access and a non-3GPP access. The 3GPP access includes, but is not limited to, an NR access, a LTE access, an NR-LEO access, an NR-MEO access, an NR-GEO access, and the like. The non-3GPP access includes, but is not limited to, a WLAN, and the like.

In order to distinguish the 3GPP accesses, the 3GPP accesses are further refined, and different access network types such as NR, LTE, NR-LEO, NR-MEO, NR-GEO accesses, and the like are referred to as radio access technology types in the embodiment of the present disclosure.

When the terminal device performs an access registration via an access network, the first network element 1401 obtains the access type and the radio access technology type corresponding to the access network.

Optionally, the first network element 1401 includes an AMF.

When the terminal device performs an access registration via two access networks, for example, NR and NR-LEO networks, each of the two access networks corresponds to one access type and one radio access technology type.

Optionally, the different network element includes, but is not limited to, an SMF, a PCF, a UDM, and other network elements.

When the terminal device initiates a registration procedure, as part of the registration procedure, the first network element 1401 needs to send the access type and the radio access technology type used by the terminal device for the access to other network elements such as an SMF, a PCF, a UDM, or the like to be saved as part of the context of the terminal device.

The first network element 1401 performs the user plane operation with the terminal device via an access network indicated by the access type and the radio access technology type.

When the access type used by the terminal device for the access is a 3GPP access, the first network element 1401 may further determine the access network used by the terminal device based on the radio access technology type used by the terminal device for the access, and may perform user-plane operations such as the establishment, modification and releasing of an MA PDU session, as well as service requests and ATSSS rule formulation with the terminal device via the access network.

For example, in case that the access network indicated by the access type and the radio access technology type used by the terminal device for the access is an NR network, then the first network element 1401 may perform user-plane operations such as the establishment, modification and releasing of an MA PDU session, as well as service requests and ATSSS rule formulation with the terminal device via the NR network.

The second network element 1402 is configured to obtain from the first network element 1401 the access type and the radio access technology type used by the terminal device for the access, and establish an MA PDU session with the terminal device via an access network indicated by the access type and the radio access technology type.

During the process of establishing or modifying the MA PDU session, the second network element 1402 obtains the access type and the radio access technology type used by the terminal device for the access from the first network element 1401.

The second network element 1402 establishes an MA PDU session with the terminal device via the access network indicated by the access type and the radio access technology type.

With the system for implementing a multi-access communication in the embodiment of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access. Thus, an access network used by the terminal device may be determined, the user plane operation with the terminal device may be performed, and the MA PDU session with the terminal device may be established.

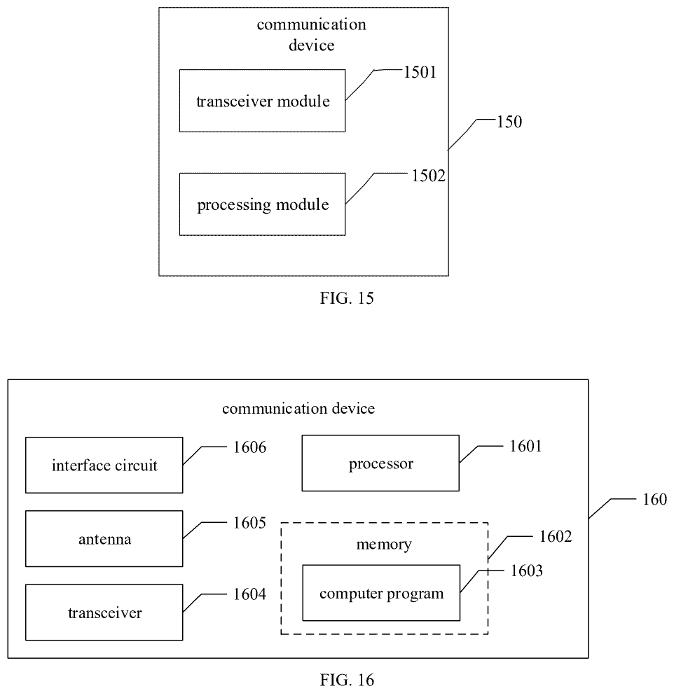

FIG. 15 is a schematic block diagram of a communication device 150 provided in an embodiment of the present disclosure. The communication device 150 shown in FIG. 15 may include a transceiver module 1501 and a processing module 1502. The transceiver module 1501 may include a sending module and/or a receiving module. The sending module is configured to implement a sending function, and the receiving module is configured to implement a receiving function. The transceiver module 1501 may implement a sending function and/or a receiving function.

The communication device 150 may be a terminal device, or an apparatus in a terminal device, or an apparatus that may be used in conjunction with a terminal device. Alternatively, the communication device 150 may be a network device, or an apparatus in a network device, or an apparatus that may be used in conjunction with a network device.

The communication device 150 is a terminal device.

The transceiver module 1501 is configured to obtain an access type and a radio access technology type used by a terminal device for an access and send the access type and the radio access technology type to a different network element. The processing module 1502 is configured to perform a user plane operation with the terminal device according to the access type and the radio access technology type.

Optionally, the transceiver module 1501 is further configured to send the access type and the radio access technology type corresponding to an access network to a UDM in a process of the terminal device initiating a registration procedure via the access network, in which the registration procedure includes at least one of an initial registration, a periodic registration, or a registration update.

Optionally, the transceiver module 1501 is further configured to send the access type and the radio access technology type to an SMF in a process of establishing or modifying an MA PDU session.

Optionally, the processing module 1502 is further configured to establish an MA PDU session with the terminal device according to the access type and the radio access technology type.

Optionally, the processing module 1502 is further configured to perform a data transmission with the terminal device based on the first PDU session and/or the second PDU session, in which the first PDU session is a PDU session established via a first access network indicated by a first access type and a first radio access technology type, and the second PDU session is a PDU session established via a second access network indicated by a second access type and a second radio access technology type.

Optionally, the processing module 1502 is further configured to receive the access type and the radio access technology type from an SMF; determine an access network indicated by the access type and the radio access technology type, and trigger the terminal device to initiate a service request procedure via the access network.

Optionally, the processing module 1502 is further configured to notify the SMF to activate a user plane connection with the terminal device in response to receiving a service request sent by the terminal device; and send request failure information for the service request to the SMF in response to not receiving the service request sent by the terminal device or rejecting the service request after receiving the service request sent by the terminal device.

The communication device 150 is a network device.

The transceiver module 1501 is configured to obtain from a first network element an access type and a radio access technology type used by a terminal device for an access. The processing module 1502 is configured to establish an MA PDU session with the terminal device via an access network indicated by the access type and the radio access technology type.

Optionally, the transceiver module 1501 is further configured to send the access type and the radio access technology type to a PCF in a process of establishing or modifying an MA PDU session.

Optionally, the transceiver module 1501 is further configured to determine the access network used for downlink data after caching the downlink data or receiving a caching notification for caching the downlink data sent by a UPF; and send a request message to the first network element, in which the request message includes the access type and the radio access technology type corresponding to the access network, and the request message is used to request the first network element to trigger the terminal device to initiate a service request procedure.

Optionally, the transceiver module 1501 is further configured to receive notification information for activating a user plane connection with the terminal device; and activate the user plane connection corresponding to the access network according to the notification information.

Optionally, the transceiver module 1501 is further configured to discard the downlink data according to request failure information for the service request, or notify the UPF to discard the downlink data and stop caching, in response to receiving the request failure information.

Optionally, the transceiver module 1501 is further configured to send the downlink data cached via the user plane connection after the user plane connection corresponding to the access network is activated.

Optionally, the processing module 1502 is further configured to release the user plane connection or a PDU session corresponding to the access network in case that the downlink data is discarded.

In the embodiment of the present disclosure, the access type and the radio access technology type used by the terminal device for the access are obtained, the access type and the radio access technology type are sent to the different network element, and the user plane operation with the terminal device is performed according to the access type and the radio access technology type. In the embodiment of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access, and thus an access network used by the terminal device may be determined and the user plane operation with the terminal device may be performed.

FIG. 16 is a schematic block diagram of another communication device 160 provided in an embodiment of the present disclosure. The communication device 160 may be a network device, or may be a terminal device, or may be a chip, a chip system, or a processor supporting the network device to implement the above-mentioned methods, or may be a chip, a chip system or a processor supporting the terminal device to implement the above-mentioned methods. The communication device 160 may be configured to implement the methods as described in the above-mentioned method embodiments. For details, reference may be made to the description in the above-mentioned method embodiments.

The communication device 160 may include one or more processors 1601. The processor 1601 may be a general-purpose processor, a special-purpose processor, or the like. The processor 1601 may be, for example, a baseband processor or a central processor. The baseband processor may be configured to process a communication protocol and communication data, and the central processor may be configured to control a communication device (such as a base station, a baseband chip, a terminal device, a terminal device chip, a DU, a CU, or the like), execute a computer program, and process data of the computer program.

Optionally, the communication device 160 may further include one or more memories 1602 on which a computer program 1603 may be stored, and the processor 1601 is configured to execute the computer program 1603 to cause the communication device 160 to perform the methods as described in the above-mentioned method embodiments. Optionally, the memory 1602 may also have data stored therein. The communication device 160 and the memory 1602 may be provided independently or integrated together.

Optionally, the communication device 160 may further include a transceiver 1604 and an antenna 1605. The transceiver 1604 may be referred to as a transceiving unit, a transceiving device, a transceiving circuit or the like for implementing a transceiving function. The transceiver 1604 may include a receiver and a transmitter, the receiver may be referred to as a receiving device, a receiving circuit or the like for implementing a receiving function; and the transmitter may be referred to as a transmitting device, a transmitting circuit or the like for implementing a transmitting function.

Optionally, the communication device 160 may further include one or more interface circuits 1606. The interface circuit 1606 is configured to receive and transmit code instructions to the processor 1601. The processor 1601 is configured to run the code instructions to enable the communication device 160 to perform the methods described in the above-mentioned method embodiments.

The communication device 160 is a terminal device configured to implement the functions of the terminal device in the aforementioned embodiments.

The communication device 160 is a network device configured to implement the functions of the network device in the aforementioned embodiments.

In an implementation, the processor 1601 may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface or the interface circuit may be configured to read and write code/data, or may be configured to transmit or transfer signals.

In an implementation, the processor 1601 may have stored therein the computer program 1603 that, when running on the processor 1601, enables the communication device 160 to perform the methods described in the above-mentioned method embodiments. The computer program 1603 may be embedded in the processor 1601, in which case the processor 1601 may be implemented by hardware.

In an implementation, the communication device 160 may include a circuit that may perform the transmitting, receiving or communicating function in the foregoing method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be fabricated with various IC process technologies, such as complementary metal oxide semiconductors (CMOSs), n-metal-oxide-semiconductors (NMOSs), positive channel metal oxide semiconductors (PMOSs), bipolar junction transistors (BJTs), bipolar CMOSs (BiCMOSs), silicon germanium (SiGe), gallium arsenide (GaAs), etc.

The communication device described in the above embodiments may be a network device or a terminal device, but the scope of the communication device described in the present disclosure is not limited thereto. The structure of the communication device may not be limited by FIG. 16. The communication device may be a stand-alone device or may be part of a larger device. For example, the communication device may be: (1) a stand-alone IC, or a chip, or a chip system or subsystem; (2) a set of one or more ICs, in which optionally, the set of ICs may further include a storage component for storing data and computer programs; (3) an ASIC, such as a modem; (4) a module that may be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc. ; (6) others.

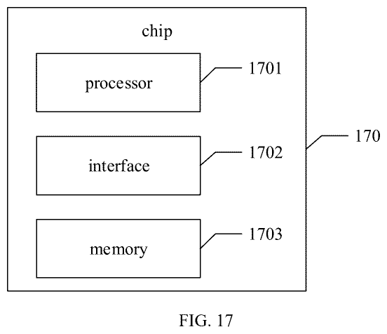

For the case where the communication device may be a chip or a chip system, reference may be made to the schematic block diagram of the chip shown in FIG. 17. The chip shown in FIG. 17 includes a processor 1701 and an interface 1702. The number of processors 1701 may be one or more, and the number of interfaces 1702 may be multiple.

For the case where the chip is configured to implement the functions of the terminal device in embodiments of the present disclosure, the following applies.

The interface 1702 is configured to obtain an access type and a radio access technology type used by a terminal device for an access and send the access type and the radio access technology type to a different network element. The processor 1701 is configured to perform a user plane operation with the terminal device according to the access type and the radio access technology type.

Optionally, the interface 1702 is further configured to send the access type and the radio access technology type corresponding to an access network to a UDM in a process of the terminal device initiating a registration procedure via the access network, in which the registration procedure includes at least one of an initial registration, a periodic registration, or a registration update.

Optionally, the interface 1702 is further configured to send the access type and the radio access technology type to an SMF in a process of establishing or modifying an MA PDU session.

Optionally, the processor 1701 is further configured to establish an MA PDU session with the terminal device according to the access type and the radio access technology type.

Optionally, the processor 1701 is further configured to perform a data transmission with the terminal device based on the first PDU session and/or the second PDU session, in which the first PDU session is a PDU session established via a first access network indicated by a first access type and a first radio access technology type, and the second PDU session is a PDU session established via a second access network indicated by a second access type and a second radio access technology type.

Optionally, the processor 1701 is further configured to receive the access type and the radio access technology type from an SMF; determine an access network indicated by the access type and the radio access technology type, and trigger the terminal device to initiate a service request procedure via the access network.

Optionally, the processor 1701 is further configured to notify the SMF to activate a user plane connection with the terminal device in response to receiving a service request sent by the terminal device; and send request failure information for the service request to the SMF in response to not receiving the service request sent by the terminal device or rejecting the service request after receiving the service request sent by the terminal device.

For the case where the chip is configured to implement the functions of the network device in embodiments of the present disclosure, the following applies.

The interface 1702 is configured to obtain from a first network element an access type and a radio access technology type used by a terminal device for an access. The processor 1701 is configured to establish an MA PDU session with the terminal device via an access network indicated by the access type and the radio access technology type.

Optionally, the interface 1702 is further configured to send the access type and the radio access technology type to a PCF in a process of establishing or modifying an MA PDU session.

Optionally, the interface 1702 is further configured to determine the access network used for downlink data after caching the downlink data or receiving a caching notification for caching the downlink data sent by a UPF; and send a request message to the first network element, in which the request message includes the access type and the radio access technology type corresponding to the access network, and the request message is used to request the first network element to trigger the terminal device to initiate a service request procedure.

Optionally, the interface 1702 is further configured to receive notification information for activating a user plane connection with the terminal device; and activate the user plane connection corresponding to the access network according to the notification information.

Optionally, the interface 1702 is further configured to discard the downlink data according to request failure information for the service request, or notify the UPF to discard the downlink data and stop caching, in response to receiving the request failure information.

Optionally, the interface 1702 is further configured to send the downlink data cached via the user plane connection after the user plane connection corresponding to the access network is activated.

Optionally, the processor 1701 is further configured to release the user plane connection or a PDU session corresponding to the access network in case that the downlink data is discarded.

Optionally, the chip further includes a memory 1703 for storing desired computer programs and data.

In the embodiments of the present disclosure, the access type and the radio access technology type used by the terminal device for the access are obtained, the access type and the radio access technology type are sent to the different network element, and the user plane operation with the terminal device is performed according to the access type and the radio access technology type. In the embodiments of the present disclosure, when the terminal device uses multiple types of 3GPP accesses to support ATSSS features, the access technologies used by the terminal device in case of the 3GPP accesses may be distinguished according to the access type and the radio access technology type used by the terminal device for the access, and thus an access network used by the terminal device may be determined and the user plane operation with the terminal device may be performed.

Those skilled in the art may also understand that various illustrative logical blocks and steps listed in embodiments of the present disclosure may be implemented by an electronic hardware, a computer software, or a combination thereof. Whether such functions are implemented by a hardware or a software depends on specific applications and design requirements of an overall system. For each specific application, those skilled in the art may use various methods to implement the functions, but such implementations should not be understood as extending beyond the protection scope of embodiments of the present disclosure.

An embodiment of the present disclosure further provides a communication system. The communication system includes the communication device as the terminal device and the communication device as the network device in the above-mentioned embodiments shown in FIG. 13. Alternatively, the communication system includes the communication device as the terminal device and the communication device as the network device in the above-mentioned embodiments shown in FIG. 14.

The present disclosure further provides a readable storage medium having stored therein instructions that, when executed by a computer, cause functions of any one of the above-mentioned method embodiments to be implemented.

The present disclosure further provides a computer program product that, when executed by a computer, causes functions of any one of the above-mentioned method embodiments to be implemented.

All or some of the above embodiments may be implemented by a software, a hardware, a firmware or any combination thereof. When implemented using the software, all or some of the above embodiments may be implemented in a form of the computer program product. The computer program product includes one or more computer programs. When the computer program is loaded and executed on the computer, all or some of the processes or functions according to embodiments of the present disclosure will be generated. The computer may be a general-purpose computer, a special-purpose computer, a computer network, or other programmable devices. The computer program may be stored in a computer-readable storage medium, or transmitted from one computer-readable storage medium to another computer-readable storage medium. For example, the computer program may be transmitted from one website, computer, server or data center to another website, computer, server or data center in a wired manner (such as via a coaxial cable, an optical fiber, a digital subscriber line DSL) or a wireless manner (for example, in an infrared, wireless, or microwave manner, or the like). The computer-readable storage medium may be any available medium that may be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc DVD), a semiconductor medium (for example, a solid state disk SSD), or the like.

Those of ordinary skill in the art can understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C”, “D”, etc., and these technical features described with the terms “first”, “second”, “third”, “A”, “B”, “C”and “D”have no order of precedence or size.

The corresponding relationships shown in the tables in the present disclosure may be configured or predefined. The values of the information in each table are only given by way of example and may be configured as other values, which are not limited in the present disclosure. When configuring the corresponding relationship between the information and each parameter, it is not necessarily required to configure all the corresponding relationships illustrated in each table. For example, in the table in the present disclosure, the corresponding relationships shown in some rows may not be configured. For another example, appropriate adjustments may be made based on the above table, such as splitting, merging, etc. The names of the parameters shown in the titles of the above tables may also use other names that may be understood by the communication device, and the values or representations of the parameters may also be other values or representations that may be understood by the communication device. When implementing the above tables, other data structures may also be used, such as arrays, queues, containers, stacks, linear lists, pointers, linked lists, trees, graphs, structures, classes, heaps, hash tables or hashed lists.

The term “predefined” in the present disclosure may be understood as defined, pre-defined, stored, pre-stored, pre-negotiated, pre-configured, solidified, or pre-burned.

Those of ordinary skill in the art will appreciate that the units and algorithm steps of each example described in conjunction with the embodiments of the present disclosure may be implemented in electronic hardware, or a combination of computer software and electronic hardware. Whether these functions are performed in hardware or software depends on the specific application and design constraints of the technical solution. Professional technicians may use different methods to implement the described functions for each specific application, but such an implementation should not be understood as extending beyond the scope of the present disclosure.

Those skilled in the art may clearly understand that, for the convenience and brevity of description, regarding the specific working processes of the systems, devices and units described above, reference may be made to the corresponding processes in the aforementioned method embodiments, which will not be repeated here.

The above is only a specific embodiment of the present disclosure, but the protection scope of the present disclosure is not limited thereto. Any person skilled in the art who is familiar with this technical field may easily think of changes or substitutions within the technical scope defined in the present disclosure, which should be included in the protection scope of the present disclosure. Therefore, the protection scope of the present disclosure should be based on the protection scope of the claims.

1. A method for implementing a multi-access communication, performed by a first network element and comprising:
obtaining an access type and a radio access technology type used by a terminal device for an access to a network;
sending the access type and the radio access technology type to a different network element; and
performing a user plane operation with the terminal device according to the access type and the radio access technology type.

2. The method according to claim 1, further comprising:
sending the access type and the radio access technology type corresponding to an access network to a unified data management (UDM) in a process of the terminal device initiating a registration procedure via the access network, wherein the different network element is the UDM and the registration procedure comprises at least one of an initial registration, a periodic registration, or a registration update.

3. The method according to claim 1, further comprising:
sending the access type and the radio access technology type to a session management function (SMF) in a process of establishing or modifying a multi-access protocol data unit (MA PDU) session, wherein the different network element is the SMF.

4. The method according to claim 1, wherein the performing the user plane operation with the terminal device according to the access type and the radio access technology type comprises:
establishing a multi-access protocol data unit (MA PDU) session with the terminal device according to the access type and the radio access technology type.

5. The method according to claim 4, wherein the MA PDU session comprises a first PDU session and a second PDU session, and the method further comprises:
performing a data transmission with the terminal device based on at least one of the first PDU session or the second PDU session, wherein the first PDU session is a PDU session established via a first access network indicated by a first access type and a first radio access technology type, and the second PDU session is a PDU session established via a second access network indicated by a second access type and a second radio access technology type.

6. The method according to claim 1, further comprising:
receiving the access type and the radio access technology type from a session management function (SMF);
determining an access network indicated by the access type and the radio access technology type, and triggering the terminal device to initiate a service request procedure via the access network.

7. The method according to claim 6, further comprising:
notifying the SMF to activate a user plane connection with the terminal device in response to receiving a service request sent by the terminal device; and
sending request failure information for the service request to the SMF in response to not receiving the service request sent by the terminal device or rejecting the service request after receiving the service request sent by the terminal device.

8. A method for implementing a multi-access communication, performed by a second network element and comprising:
obtaining from a first network element an access type and a radio access technology type used by a terminal device for an access to a network;
establishing a multi-access protocol data unit (MA PDU) session with the terminal device via an access network indicated by the access type and the radio access technology type.

9. The method according to claim 8, further comprising:
sending the access type and the radio access technology type to a policy control function (PCF) in a process of establishing or modifying an MA PDU session.

10. The method according to claim 8, further comprising:
determining the access network used for downlink data after caching the downlink data or receiving a caching notification for caching the downlink data sent by a user plane function (UPF);
sending a request message to the first network element, wherein the request message comprises the access type and the radio access technology type corresponding to the access network, and the request message is used to request the first network element to trigger the terminal device to initiate a service request procedure.

11. The method according to claim 10, further comprising:
receiving notification information for activating a user plane connection with the terminal device;
activating the user plane connection corresponding to the access network according to the notification information.

12. The method according to claim 10, further comprising:
in response to receiving request failure information for the service request, discarding the downlink data according to the request failure information, or notifying the UPF to discard the downlink data and stop caching.

13. The method according to claim 10, further comprising:
sending the downlink data cached via user plane connection after the user plane connection corresponding to the access network is activated.

14. The method according to claim 12, further comprising:
releasing the user plane connection or a PDU session corresponding to the access network in case that the downlink data is discarded.

15-18. (canceled)

19. A communication device, comprising:
a processor; and
a memory having stored therein a computer program,
wherein the processor is configured to:
obtain an access type and a radio access technology type used by a terminal device for access to a network;
send the access type and the radio access technology type to a different network element;
perform a user plane operation with the terminal device according to the access type and the radio access technology type.

20. A communication device, comprising:
a processor; and
a memory having stored therein a computer program,
wherein the processor is configured to perform the method according to claim 8.

21. A communication device, comprising:
a processor; and
an interface circuit configured to receive code instructions and transmit the code instructions to the processor,
wherein the processor is configured to run the code instructions to perform the method according to claim 1.

22. A communication device, comprising:
a processor; and
an interface circuit configured to receive code instructions and transmit the code instructions to the processor,
wherein the processor is configured to run the code instructions to perform the method according to claim 8.

23. The communication device according to claim 19, wherein the processor is further configured to:
send the access type and the radio access technology type corresponding to an access network to a unified data management (UDM) in a process of the terminal device initiating a registration procedure via the access network, wherein the different network element is the UDM and the registration procedure comprises at least one of an initial registration, a periodic registration, or a registration update.

24. The communication device according to claim 19, wherein the processor is further configured to:
send the access type and the radio access technology type to a SMF in a process of establishing or modifying a multi-access protocol data unit (MA PDU) session, wherein the different network element is the SMF.
